(19) United States
(12) Patent Application Publication
(10) Pub. No.: US 2001/0035304 A1
(43) Pub. Date: Nov. 1, 2001

(54) Unmanned vehicle for displacing manure

(75) Inventor: Karel van den Berg, Bleskensgraaf (NL)

Correspondence Address: MASON, MASON & ALBRIGHT, 2306 South Eads Street, P.O. Box 2246, Arlington, VA, 22202, US

(73) Assignee: Lely Research Holding A.G. , a limited liability Company

(21) Appl. No.: 09/768,441

(22) Filed: Jan. 25, 2001

Related U.S. Application Data
(63) Continuation of application No. PCT/NL00/00314, filed on May 10, 2000.

(30) Foreign Application Priority Data
May 25, 1999 (NL) 1012143

(51) Int. Cl. B62D 11/04

(52) U.S. Cl. 180/6.48

(57) ABSTRACT

An unmanned vehicle for displacing manure from the floor of a stable of the type used for dairy cattle. The vehicle comprises a steering unit and a frame to which are attached two wheels driven by separate motors at different control speeds for steering the vehicle as well as propelling and supporting it. Attached to the frame forward of the two wheels is a manure displacing member for displacing manure on the floor and which also serves the purpose of supporting the vehicle. Forward of the manure displacing member is a coaster. The vehicle also includes orientation apparatus for determining the relative position of the vehicle and guidance apparatus for determining and controlling the course which the vehicle follows for displacing manure from the stable floor. It further includes an anti-bumping device which senses obstacles and controls the vehicle to avoid them and prevents the vehicle from moving away from the area of the stable floor.

### RELATED APPLICATION

This Application is a continuation of International Application No. PCT/NL00/00314, filed May 10, 2000.

### FIELD OF THE INVENTION

The invention relates to an unmanned vehicle for displacing manure over a stable floor.

### BACKGROUND OF THE INVENTION

Modern stables usually have a stable floor in which apertures are provided for receiving cow manure therethrough. Under the stable floor is a receptacle that collects the manure which passed through the apertures. Generally there is also provided in the stable a so-called manure slide which moves through the stable at fixed points of time and displaces the manure partially to a dung pit and partially through the apertures in the stable floor.

A new development is an unmanned vehicle for displacing manure. Such an implement is known from Messrs. Joz B. V. as the JOZTECH (Landbouw Rai (Agricultural Rai), Amsterdam, January 1999). This implement is provided with a first propelling unit comprising two freely rotatable wheels and a second propelling unit comprising one driven and controllable wheel. The disadvantage of said implement is that the construction of the drive and controllable wheel is complicated and therefore expensive. Moreover, the construction is very sensitive to dirt, which is not desirable in the stable environment. Finally, the JOZTECH is driven by only one controllable wheel, so wheel skidding often occurs on the stable floor which is very slippery due to the presence of manure. As a result thereof it is not possible to determine the exact position of the vehicle on the basis of the number of the driven wheel's revolutions.

### SUMMARY OF THE INVENTION

The invention aims to obviate the above-mentioned drawbacks by means of an unmanned vehicle by providing a steering unit having two independently driven propelling members which also constitute a steering unit. Thus an advantage of this unmanned vehicle is that the drive unit of the propelling members also constitutes its steering unit. Accordingly, there is achieved a compact construction which is insensitive to dirt and which is, in addition, less complicated, so that lower manufacturing costs are involved.

According to a further inventive feature, at least one of the supporting means is provided with pressure setting means for setting the pressure with which the manure displacing means applies on the floor. Therefore, the invention relates to an unmanned vehicle for displacing manure over a stable floor, comprising a steering unit for steering the vehicle and a frame with first, second and third supporting means for supporting the frame on the floor, while the first and second supporting means are rollable relative to the floor and the third supporting means comprises manure displacing means for displacing manure, the first supporting means also comprising a propelling unit for propelling the vehicle, characterized in that at least one of the supporting means is provided with pressure setting means for setting the pressure with which the manure displacing means applies on the floor. The second propelling unit comprises at least one freely rotatable propelling member. The propelling members are preferably designed as a wheel or a caterpillar track or both. In a preferred embodiment the rotatable propelling member consists of a castor wheel as a result of which the unmanned vehicle has an excellent maneuverability. Caterpillar tracks have the advantage of being less sensitive to skidding than wheels.

In accordance with another inventive feature, the unmanned vehicle is equipped with orientation means for following a course in a space, or determining the position of the vehicle in a space, such as a stable or a meadow. The orientation means comprises floor detection means for detecting apertures in the floor or detecting a guide means in the floor, such as reinforcement in the concrete or an electricity conducting wire or a combination thereof. The apertures in the floor are usually provided for removing the manure as described above. When the stable floor is made of concrete, the floor usually has a metal grid to give it extra strength. Said grid can be detected by means of the floor detection means with the aid of an induction coil, for example. Additional orientation means may comprise a compass or a gyroscope or a spirit level or a clinometer or an acceleration meter or a combination of these components. These orientation means are presently available in forms which are suitable for inclusion in electronic circuits, so that integrated orientation means can easily be constructed from the various components.

The orientation means may also comprise wall following means for detecting and following a wall, such as a fixed stable wall or the edge or a cubicle. These wall following means extend over at least part of the circumference of the unmanned vehicle. The wall following means may also be disposed on the manure displacing means. In a preferred embodiment, the wall following means consists of a freely rotating substantially circular element, such as preferably a wheel or a disc or a sphere.

According to another inventive feature, the unmanned vehicle is equipped with protective facilities for protecting the vehicle against obstacles, such as cows' legs, or fixed objects, such as supporting pillars in the stable. The protective facilities may comprise a bumper or a sensor for detecting cows, or both. The protective facilities may also comprise wall following means or positioning means for determining the position of an obstacle relative to the unmanned vehicle. The positioning means may also comprise a clinometer or an acceleration meter. The positioning means are preferably disposed on the wall following means. In this manner it is possible to determine the angular deflection and angular acceleration of the wall following means, so that information is obtained regarding the position of the obstacle. The signal from the positioning means is used for actuating the steering unit.

The manure displacing means preferably comprises at least one brush or at least one manure slide or at least one spraying unit, or a combination thereof.

In accordance with a further inventive feature, the unmanned vehicle is equipped with anti-bumping means for preventing the manure displacing means from moving too far away from the floor. The anti-bumping means comprises a bumper or a bracket or both. The anti-bumping means preferably comprises an anti-bumping sensor for detecting the movement of the manure displacing means away from the floor, which anti-bumping sensor is coupled to the propelling unit. Such an anti-bumping sensor may consist of a switch which is disposed on the bumper or bracket. When the manure slide moves too far away from the stable floor, the switch touches the stable floor, whereupon the unmanned vehicle is caused to run in an opposite direction and bears again with all its supporting means on the stable floor.

### BRIEF DESCRIPTION OF THE DRAWING

The Invention will now be explained in further detail with reference to the accompanying drawing, in which:

FIGURE 1 is a plan view of the unmanned vehicle.

### DETAILED DESCRIPTION OF THE PREFERRED EMBODIMENTS:

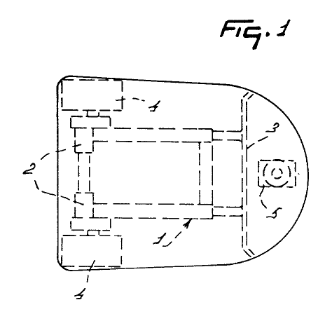

The unmanned vehicle as shown in FIGURE 1 consists of a frame 1 to which are fitted a castor wheel 5, a propelling unit 2 and a manure slide 3. The steering unit is constituted by propelling unit 2, which propelling unit 2 comprises two independently driven wheels 4. In this embodiment maneuvering the vehicle is possible by varying the drive torque or the peripheral velocity of wheels 4. Wheels 4 are rollable endless members which may comprise a wheel or a caterpillar track or both.

Although I have disclosed the preferred embodiments of my invention, it is to be understood that it is capable of other adaptations and modifications within the scope of the following claims:

1. An unmanned vehicle for displacing manure over a stable floor, comprising a steering unit for steering the vehicle and a frame (1) with first, second and third supporting means for supporting the frame (1) on the floor, while the first and second supporting means are rollable relative to the floor and the third supporting means comprise manure displacing means for displacing a manure, the first supporting means comprising a propelling unit (2) for propelling the vehicle, characterized in that the propelling unit comprises two independently drivable propelling members and the steering unit is constituted by the propelling unit.
